(19) United States
(12) Patent Application Publication
(10) Pub. No.: US 2012/0144681 A1
(43) Pub. Date: Jun. 14, 2012

(54) CUTTING MACHINE

(75) Inventors: Masahiko INAI, Anjo-shi (JP); Masanori HAYASHI, Anjo-shi (JP)

(73) Assignee: MAKITA CORPORATION, Anjo-shi (JP)

(21) Appl. No.: 13/291,501

(22) Filed: Nov. 8, 2011

(30) Foreign Application Priority Data
Dec. 10, 2010 (JP) 2010-275945

(51) Int. Cl. B23D 51/00; B27G 3/00; B23D 49/10

(52) U.S. Cl. 30/516

(57) ABSTRACT

The present invention provides a cutting machine in which a reciprocating rod is driven by a motor and projects downward at a forward portion of a housing. The housing accommodates the motor and a cooling fan for cooling the motor, and a lower end of the rod is connected to a cutting blade for cutting a workpiece. A first blow passage is provided in the housing, and cooling air generated by the cooling fan forwardly flows in a direction intersecting the rod from a rear side of the rod.

### BACKGROUND OF THE INVENTION

This application claims the benefit of Japanese Patent Application Number 2010-275945 filed on Dec. 10, 2010, the entirety of which is incorporated by reference.

### TECHNICAL FIELD

The present invention relates to a cutting machine in which a reciprocating rod driven by a motor projects downward at a forward portion of a housing that accommodates the motor and a cooling fan for cooling the motor, and a lower end of the rod is connected to a cutting blade to cut a workpiece.

### BACKGROUND OF THE INVENTION

Japanese Patent No. 4248766B discloses a cutting machine which cuts a workpiece with a blade connected to a lower end of a reciprocating rod projecting downward at a forward portion of a housing, so as to prevent the scattering of chips generated from the workpiece being cut by the blade. With the cutting machine, an outlet of a nozzle from which air for cooling a motor blows on a front side of the blade opens rearward so that cooling air gently blows rearward from the front side of the blade. Such cooling air functions as an air curtain that forwardly covers a cutting place of the workpiece. In other words, the cooling air, blocks the chips from scattering forwardly.

However, even though the forward scattering of the chips can be suppressed with the cutting machine described above, it is a point of concern that the chips blows up from the cutting place and enters the housing from the projecting section of the rod in the housing.

### SUMMARY OF THE INVENTION

Under the foregoing circumstances, an object of the present invention is to provide a cutting machine that can prevent the chips from entering a housing from a section where a rod connected to a blade projects from the housing.

According to a first aspect of the present invention, a cutting machine includes a housing, a motor and a cooling fan for cooling the motor that are accommodated in the housing, a reciprocating rod driven by the motor, projecting downward at a forward portion of the housing, a cutting blade for cutting a workpiece, being connected to a lower end of the rod, and a first blow passage formed in the housing. Cooling air generated by the cooling fan forwardly flows through the first blow passage in a direction intersecting the rod from a rear side relative to the rod.

According to a second aspect of the present invention, in the cutting machine of the first aspect, a pair of the first blow passages are provided in the housing, and the cooling air through the first blow passage flows leftward and rightward from the rear side of the rod.

According to a third aspect of the present invention, in the cutting machine of the first aspect, a second blow passage is formed in the housing and the cooling air flows through the second blow passage toward a cutting place of the workpiece being cut by the cutting blade.

According to a fourth aspect of the present invention, in the cutting machine of the third aspect, the first blow passage and the second blow passage are formed branching from a downwind side of the cooling fan.

According to a fifth aspect of the present invention, the cutting machine of the third aspect further includes a cover member attached to a lower portion of the housing. The cover member covers from the first blow passage and the second blow passage to the forward portion of the housing, wherein between an outer surface of the housing and an inner surface of the cover member, the cooling air blown through the first blow passage is guided toward the rod, while the cooling air blown through the second blow passage is guided toward the cutting place.

According to a sixth aspect of the present invention, a cutting machine includes a housing, a motor and a cooling fan for cooling the motor that are accommodated in the housing, a reciprocating rod driven by the motor projecting downward at a forward portion of the housing, a cutting blade for cutting a workpiece, being connected to a lower end of the rod through a connecting body, and a blow passage formed in the housing. Further, the cooling air generated by the cooling fan flows through the blow passage toward the connecting body at a top dead center position.

According to the cutting machine in the first and sixth aspects of the present invention, chips generated from the workpiece being cut by the blade are scattered forward the rod by the cooling air blown from the first blow passage. Therefore, the chips can be prevented from entering the housing from the projecting section of the rod on the housing.

According to the second aspect of the present invention, the chips are forwardly scattered from both the left and right sides of the rod, so as to block the chips from heading toward the projecting section of the rod on the housing from leftward and rightward of the rod. Therefore, the chips can be effectively prevented from entering the housing from the projecting section.

According to the third aspect of the present invention, the chips generated in the cutting place are scattered by the cooling air blown from the second blow passage. Therefore, a user can keep sight of a cut line drawn on the workpiece and an edge of the cutting blade when the cutting blade cuts the workpiece. Consequently, visibility of the blade edge and the cut line (cutting position) is improved and therefore an efficiency of the cutting operation is increased.

According to the fourth aspect of the present invention, compared to a configuration in which the first and second blow passages are formed separately, the blow passages can be provided in a practical and compact manner.

According to the fifth aspect of the present invention, the cooling air blown from the first and second blow passages flows between the outer surface of the housing and the inner surface of the cover member along the inner surface. At this time, cooling air is reliably guided toward the rod and the cutting place so as to flow toward the rod and the cutting place without being affected by the flow of air around the cutting machine.

### BRIEF DESCRIPTION OF THE DRAWINGS

FIG. 1 is a drawing that shows an overall perspective view of a jigsaw according to an embodiment of the present invention with a cover member removed from a housing.

FIG. 2 is a side view of the jigsaw with the cover member removed from the housing.

FIG. 3 is a bottom view of an essential portion of the jigsaw with the cover member removed from the housing.

FIG. 4 is a cross-sectional view of an essential portion of the jigsaw.

### DETAILED DESCRIPTION OF THE EMBODIMENT

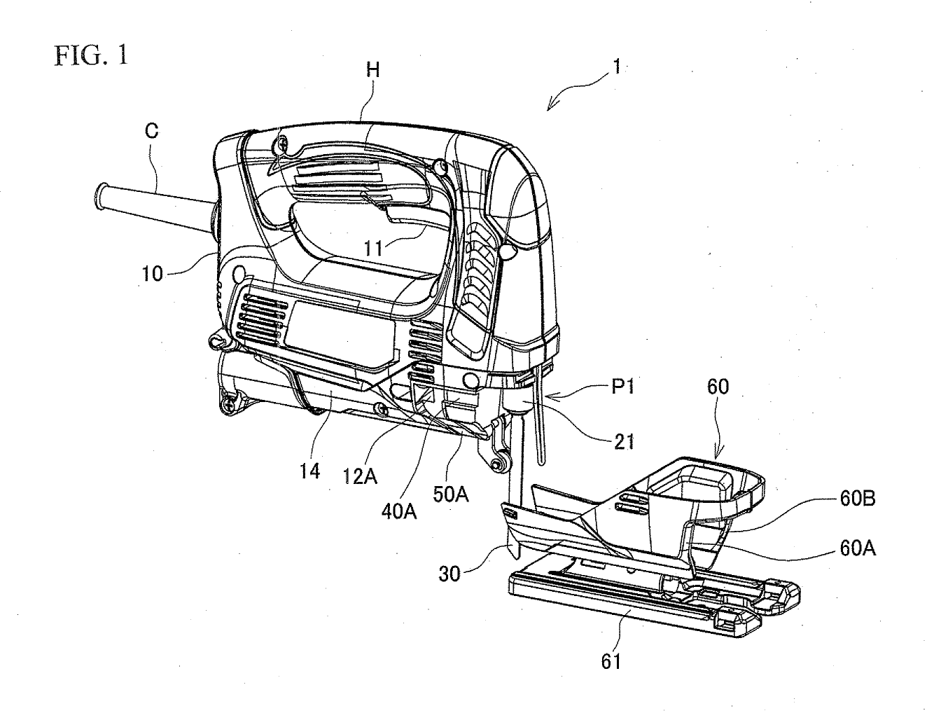

An embodiment of the present invention will be described with reference to FIGS. 1 to 4. A jigsaw 1 as shown in FIGS. 1 to 4 includes a housing 10, a rod 20, a blade 30, a first blow passage 40 (40A, 40B), a second blow passage 50 (50A, 50B), and a cover member 60. The jigsaw 1 is one example of a cutting machine according to the present invention.

The housing 10 is formed by assembling together left and right half housings made of resin. A handle H is provided on top of the housing 10. The handle H accommodates a switch including a trigger 11 for activating and deactivating the jigsaw 1. A power cord C supplying power to the jigsaw 1 is attached at a rear end of the housing 10 (left side in FIGS. 1 to 4).

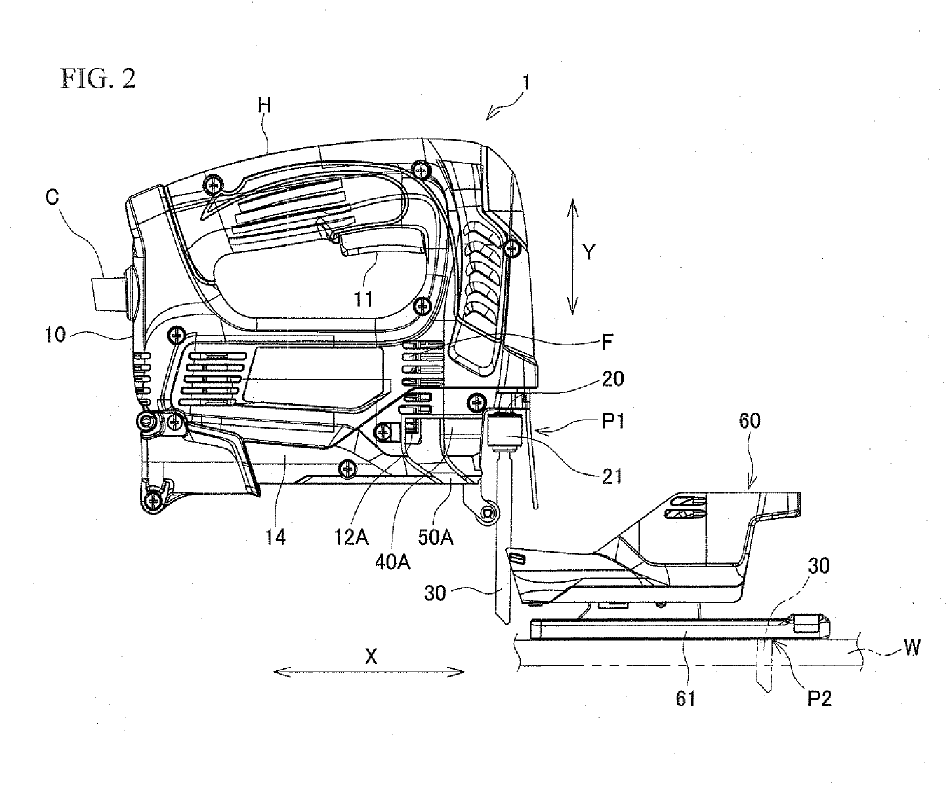

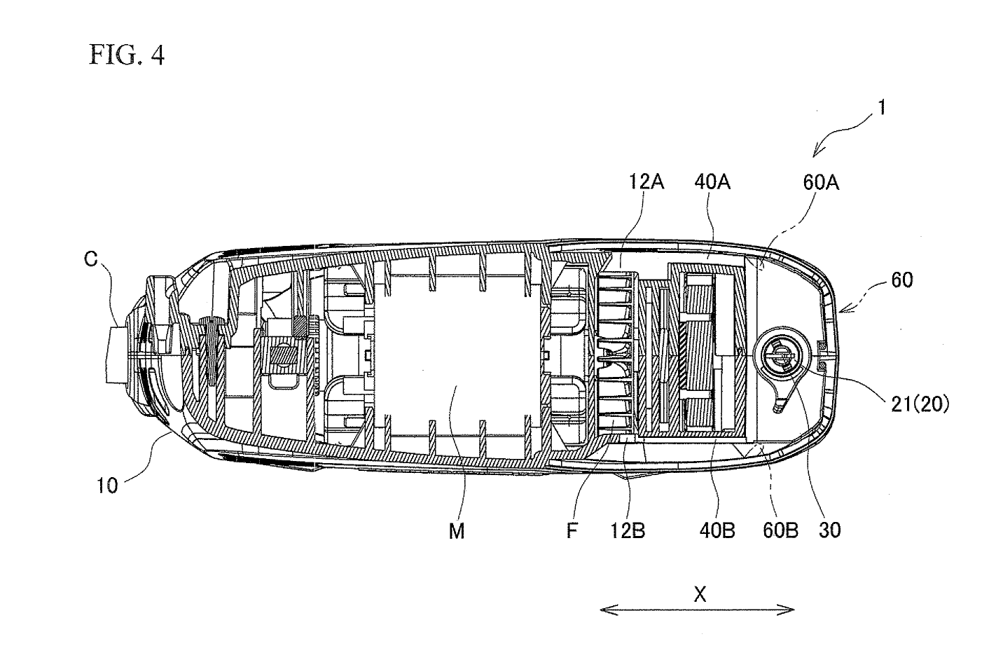

A motor M as a drive power source (see FIG. 4) is accommodated in a center portion of the housing 10, and a reciprocating mechanism (not shown) is accommodated in a forward portion of the housing. An output shaft of the motor M is attached to a fan F for cooling the motor M, and meshes with a drive gear of the reciprocating mechanism. Further, in the forward portion of the housing 10, a rod 20 is reciprocably supported in an up-down direction Y (see FIG. 2) of the housing 10 by the reciprocating mechanism, and a lower end portion of the rod 20 projects downward from the housing 10. The lower end portion of the rod 20 is provided with a blade attachment portion 21, and a base end portion of the linear blade 30 is detachably connected to the blade attachment portion 21. The blade 30 is one example of a cutting blade according to the present invention, and the blade attachment portion 21 is one example of a connecting body according to the present invention.

As shown in FIGS. 1, 2, and 4, an air outlet 12A is formed in a left side surface of the housing 10 near a downwind side of the cooling fan F, while an air outlet 12B is formed in a right side surface of the housing 10 near the downwind side. The first blow passage 40A and the second blow passage 50A are formed branching from the air outlet 12A in the left side surface, as shown in FIGS. 1 and 2. Further, the first blow passage 40B and the second blow passage 50B are formed branching from the air outlet 12B in the right side surface. It should be noted that the top side of FIG. 4 corresponds the left side of the housing 10, and the bottom side of FIG. 4 corresponds the right side of the housing 10.

The first blow passage 40A is formed as a recessed groove extending in a front-rear direction X of the housing 10 on the left side surface of the housing 10. An upstream end of the first blow passage 40A communicates with the air outlet 12A, and a downstream end of the first blow passage 40A opens toward a front surface of the housing 10 and extends from a left rear side of the rod 20 toward a top dead center position P1 of the blade attachment portion 21. Meanwhile, the first blow passage 40B is formed as a recessed groove extending in the front-rear direction X on the right side surface of the housing 10. An upstream end of the first blow passage 40B communicates with the air outlet 12B, and a downstream end of the first blow passage 40B opens similar to the first blow passage 40A and extends from a right rear side of the rod 20 toward the top dead center position P1. The first blow passages 40A, 40B are examples of a blow passage according to the present invention.

As shown in FIGS. 1 to 3, the second blow passage 50A is formed as a recessed groove which is inclined forward and extends along the left side surface of the housing 10 toward a cutting place P2 of a workpiece W. An upstream end of the second blow passage 50A communicates with the air outlet 12A, and a downstream end of the second blow passage 50A opens toward a bottom surface of the housing 10 and extends from a left rear side of the blade 30 toward the cutting place P2.

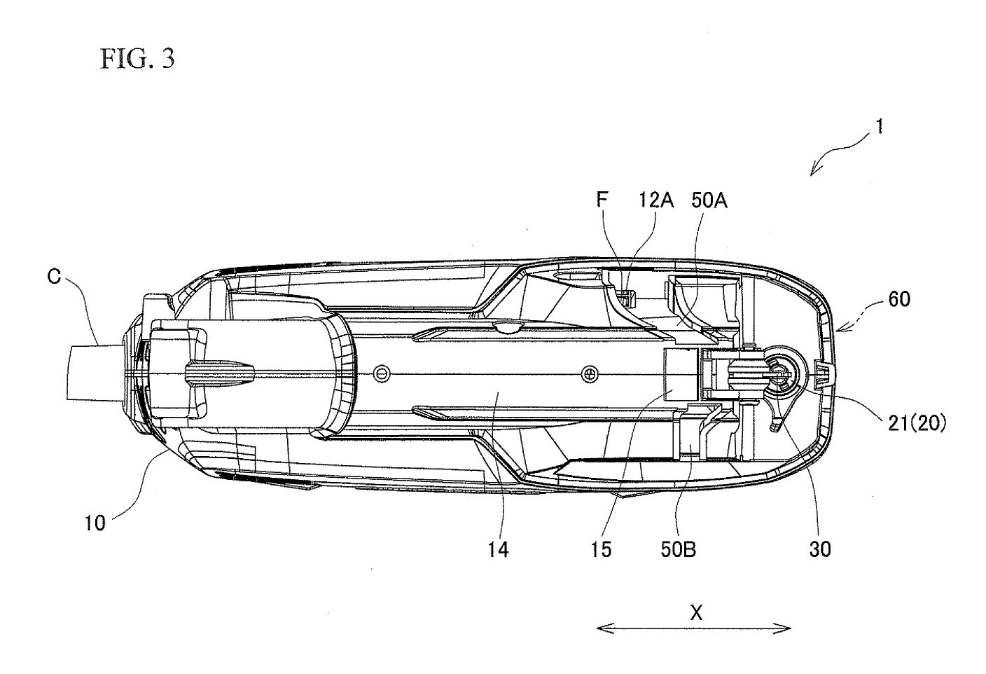

The second blow passage 50B is formed as a recessed groove which is inclined forward and extends along the right side surface of the housing 10 toward the cutting place P2. An upstream end of the second blow passage 50B communicates with the air outlet 12B, and a downstream end of the second blow passage 50B opens similar to the second blow passage 50A and extends from a right rear side of the blade 30 toward the cutting place P2. It should be noted that the top side of FIG. 3 corresponds the left side of the housing 10 and the left side of the blade 30, and the bottom side of FIG. 3 corresponds the right side of the housing 10 and the right side of the blade 30.

In a lower portion of the housing 10, as shown in FIGS. 1 to 3, a hollow dust collection passage 14 is formed extending in the front-rear direction X. A dust collection opening 15 is formed in a front lower surface of the dust collection passage 14. When a dust collector connected to the dust collection passage 14 operates, chips generated in the cutting place P2 are suctioned inside the dust collection passage 14 through the dust collection opening 15.

The cover member 60 is threadably attached to the lower portion of the housing 10. The cover member 60 is made of aluminum and molded into a substantially U-shaped configuration as viewed from the front, as shown in FIGS. 3 and 4. The cover member 60 covers, in a non-contacting manner, the air outlets 12A, 12B, the first blow passages 40A, 40B, the second blow passages 50A, 50B in the lower portion of the housing 10, and the projecting section of the rod 20 at the forward portion of the housing 10. As shown in FIGS. 1 and 4, a front section of the cover member 60 is formed with a left wall portion 60A that is continuous from a left side surface of the cover member 60 and projects diagonally forward and inward of the cover member 60, and a right wall portion 60B that is continuous from a right side surface of the cover member 60 and projects diagonally forward and inward of the cover member 60. After attaching the cover member 60 to the housing 10, outer sides of each of the blow passages 40A, 40B, 50A, 50B are covered by an inner surface of the cover member 60. The left wall portion 60A projects toward the left side of the rod 20, and the right wall portion 60B projects toward the right side of the rod 20. As shown in FIGS. 1 and 2, a base 61 contacting an upper surface of the workpiece W is provided continuous from a lower portion of the cover member 60.

Next, the operation of the jigsaw 1 will be described. By contacting the base 61 with the upper surface of the workpiece W and pressing the trigger 11 toward the inside of the handle H, the switch is set to an ON state and the motor M starts driving. The drive gear of the reciprocating mechanism rotates accordingly, and the rod 20 and the blade 30 reciprocate in the up-down direction Y, thereby cutting the workpiece W along a cut line drawn on the workpiece W. In addition, driving of the motor M is accompanied by rotating of the cooling fan F, whereby air for cooling the motor M is suctioned inside the housing 10 through an inlet of the housing 10 and cools the motor M. The cooling air subsequently flows toward the downwind side of the cooling fan F, and such air is then blown from the air outlet 12A and guided toward the first blow passage 40A and the second blow passage 50A. The cooling air is also blown from the air outlet 12B and guided toward the first blow passage 40B and the second blow passage 50B.

The cooling air guided by the second blow passages 50A, 50B flows downward along the inner surface of the cover member 60 through a space between the blow passages 50A, 50B and the inner surface. Then, the cooling air flows toward the cutting place P2 and scatters the chips generated in the cutting place P2. Meanwhile, the cooling air guided by the first blow passage 40A flows along the inner surface of the cover member 60 and then flows from the left side of the rod 20 in a direction intersecting the rod 20 due to the left wall portion 60A. Thus, the cooling air scatters the chips blown upward from the cutting place P2 forward the rod 20. The cooling air guided by the first blow passage 40B similarly flows along the inner surface of the cover member 60 and then flows from the right side of the rod 20 in a direction intersecting the rod 20 due to the right wall portion 60B. Thus, the cooling air scatters the blown-upward chips forward the rod 20. The cooling air flowing in this manner forwardly scatters the chips leftward and rightward the rod 20, which can prevent the chips from heading toward the projecting section of the rod 20. The first blow passages 40A, 40B are an example of a pair of first blow passages according to the present invention.

If the blade 30 is reciprocated in the up-down direction Y to cut the workpiece W with the handle H placed at a bottom and the dust collection passage 14 placed at a top, the chips fall from the cutting place P2 toward the projecting section side of the rod 20 located below. In this case as well, the cooling air which flows leftward and rightward the rod 20 scatters the chips falling from the cutting place P2 forward the rod 20 by the cooling air. Therefore, the chips can be prevented from entering the housing 10 from the projecting section.

### Effects of the Embodiment

With the jigsaw 1 of the present embodiment, chips generated from the workpiece W being cut by the blade 30 are scattered forward the rod 20 by the cooling air from the downwind side of the cooling fan F. The cooling air flows in two directions of which one is guided through the air outlet 12A to the first blow passage 40A, and the other is guided through the air outlet 12B to the first blow passage 40B. Therefore, the chips can be prevented from entering the housing 10 from the projecting section of the rod 20 in the housing 10.

When the cooling air guided toward the first blow passages 40A, 40B flows forward and is guided the leftward and rightward the rod 20, the chips are scattered forward from both the left and right sides of the rod 20. Therefore, the chips are blocked from heading toward the projecting section on the housing 10 from the leftward and rightward of the rod 20, so that the chips can be effectively prevented from entering the housing 10 from the projecting section.

The chips generated in the cutting place P2 are scattered by the cooling air from the downwind side of the cooling fan F. The cooling air is guided through the air outlet 12A to the second blow passage 50A and through the air outlet 12B to the second blow passage 50B. Therefore, a user can keep sight of a cut line drawn on the workpiece and an edge of the cutting blade when the cutting blade cuts the workpiece. As a result, better visibility of the blade edge and the cut line (cutting position) can be achieved, which increases in the efficiency of the cutting operation.

In addition, the first blow passage 40A and the second blow passage 50A are formed branching from the air outlet 12A formed near the downwind side of the cooling fan F. Therefore, the blow passages 40A, 50A can be provided in a narrower space compared to when the first blow passage 40A and the second blow passage 50A are formed separately. Thus, the blow passages 40A, 50A can be formed in a practical and compact manner.

The first blow passage 40B and the second blow passage 50B are also formed branching from the air outlet 12B formed near the downwind side. Therefore, the blow passages 40B, 50B can be formed in a practical and compact manner similar to the blow passages 40A, 50A.

The cooling air guided toward the first blow passages 40A, 40B flows between an outer surface of the housing 10 and the inner surface of the cover member 60 along the inner surface, and is guided toward the rod 20. Meanwhile, the cooling air guided toward the second blow passages 50A, 50B flows downward between the outer surface of the housing 10 and the inner surface of the cover member 60, and is guided toward the cutting place P2. Therefore, the cooling air can be reliably guided toward the rod 20 and the cutting place P2 without being affected by the flow of air around the jigsaw 1.

The present invention is not limited to the embodiment described above, and a configuration thereof may be partially modified as appropriate and practiced without departing from the scope of the invention. For example, although the first blow passages 40A, 40B are formed on the left and right side surfaces of the housing 10 in the embodiment described above, the present invention is not limited to this example. One first blow passage may be formed inside the housing 10 as communicating with the downwind side of the cooling fan F, and the downstream end of the first blow passage may open directly behind the rod 20 and blow the cooling air such that the cooling air flows forwardly in a direction perpendicular to the rod 20. Alternatively, two or more first blow passages may be formed inside the housing 10 as communicating with the downwind side of the cooling fan F, and the downstream ends of the first blow passages may open toward the rod 20.

In addition, although the second blow passages 50A, 50B are formed on the left and right side surfaces of the housing 10 in the embodiment described above, the present invention is not limited to this example. One second blow passage may be formed inside the housing 10 as communicating with the downwind side of the cooling fan F, and the downstream end of the second blow passage may open in the bottom surface of the housing 10 toward the cutting place P2. If the first blow passage is also formed inside the housing 10 as described above, the second blow passage may be formed branching with the first blow passage from the downwind side of the cooling fan F inside the housing 10.

Moreover, in the embodiment described above, the first blow passage 40A (40B) and the second blow passage 50A (50B) are each formed branching from the air outlet 12A (12B). However, the present invention is not limited to this example. As another example, one first blow passage and two or more second blow passages may be formed branching from the respective air outlets 12A, 12B.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A cutting machine, comprising:
a housing;
a motor accommodated in the housing;
a cooling fan that is accommodated in the housing and cools the motor;
a reciprocating rod driven by the motor, projecting downward at a forward portion of the housing;
a cutting blade for cutting a workpiece, being connected to a lower end of the rod; and
a first blow passage that is formed in the housing and cooling air generated by the cooling fan forwardly flows through the first blow passage in a direction intersecting the rod from a rear side relative to the rod.

2. The cutting machine according to claim 1, wherein
a pair of the first blow passages is provided in the housing and the cooling air flows through the first blow passages leftward and rightward from the rear side of the rod.

3. The cutting machine according to claim 1, wherein
a second blow passage are provided in the housing and the cooling air flows through the second blow passage toward a cutting place of the workpiece being cut by the cutting blade.

4. The cutting machine according to claim 3, wherein
the first blow passage and the second blow passage are formed branching from a downwind side of the cooling fan.

5. The cutting machine according to claim 3, further comprising:
a cover member that is attached to a lower portion of the housing, and covers from the first blow passage and the second blow passage to the forward portion of the housing, wherein
between an outer surface of the housing and an inner surface of the cover member, the cooling air blown from the first blow passage is guided toward the rod and the cooling air blown from the second blow passage is guided toward the cutting place.

6. The cutting machine according to claim 4, wherein
an air outlet from which the cooling air blows is formed on each of left and right side surfaces of the housing on the downwind side of the cooling fan, and the first blow passage and the second blow passage are formed branching from the air outlet on each of the left and right side surfaces.

7. The cutting machine according to claim 6, wherein
the first blow passage and the second blow passage are each formed as a recessed groove.

8. The cutting machine according to claim 7, wherein
an upstream end of the first blow passage communicates with the air outlet, and a downstream end of the first blow passage is connected to a front surface of the housing and opens toward the rod.

9. The cutting machine according to claim 7, wherein
an upstream end of the second blow passage communicates with the air outlet, and a downstream end of the second blow passage is connected to a bottom surface of the housing and opens toward the cutting place.

10. The cutting machine according to claim 5, wherein
with the cover member attached to the lower portion of the housing, a front end edge of the cover member is formed with a left wall portion that is continuous from a left side surface of the cover member and projects toward a left side of the rod, and formed with a right wall portion that is continuous from a right side surface of the cover member and projects toward a right side of the rod.

11. The cutting machine according to claim 10, wherein
a base that projects downward and contacts an upper surface of the workpiece is provided continuous from the cover member.

12. A cutting machine, comprising:
a housing;
a motor accommodated in the housing;
a cooling fan that is accommodated in the housing and cools the motor;
a reciprocating rod driven by the motor, projecting downward at a forward portion of the housing;
a cutting blade for cutting a workpiece, being connected to a lower end of the rod through a connecting body; and
a blow passage that is formed in the housing and cooling air generated by the cooling fan flows through the blow passage toward the connecting body at a top dead center position.

13. The cutting machine according to claim 12, wherein
an air outlet from which the cooling air blows is formed on each of left and right side surfaces of the housing on a downwind side of the cooling fan, and the blow passage is formed as a recessed groove on each of the left and right side surfaces, wherein an upstream end of the blow passage communicates with the air outlet, and a downstream end of the blow passage is connected to a front surface of the housing and opens toward the connecting body.
